(19) United States
(12) Patent Application Publication
(10) Pub. No.: US 2023/0016014 A1
(43) Pub. Date: Jan. 19, 2023

(54) COATED ELECTRODE WITH POLYMERIC BINDERS FOR LITHIUM ION BATTERY

(71) Applicant: Arkema Inc., King of Prussia, PA (US)

(72) Inventors: Thomas J. Fine, Lyon (FR); Shinae Park, Seoul (KR)

(21) Appl. No.: 17/783,676

(22) PCT Filed: Nov. 23, 2020
(86) PCT No.: PCT/US2020/061754

§ 371 Date: Jun. 9, 2022

Related U.S. Application Data
(60) Provisional application No. 62/952,620, filed on Dec. 23, 2019.

(51) Int. Cl. H01M 4/62; H01M 10/0525; H01M 4/583; H01M 4/04

(52) U.S. Cl. CPC H01M 4/623; H01M 10/0525; H01M 4/583; H01M 4/0421; H01M 2004/021

(57) ABSTRACT

Disclosed is a method for producing a battery electrode using a granulated polymeric binder composition where the binder composition comprises agglomerated particles wherein greater than 95% by weight of agglomerated particles are 400 um or greater but less than 2.5 mm and a bulk density of greater than 0.4 g/cc.

### FIELD OF THE INVENTION

The invention relates to a polymeric binder composition used in coating in electrochemical devices.

### BACKGROUND OF THE INVENTION

Electrodes are used in energy storing devices, including but not limited to, batteries, capacitors, ultra-capacitors, non-aqueous-type secondary batteries and such.

Currently there are two primary means for producing electrodes: a “wet” method and a “dry” method. In the wet method, a polymeric binder in the form of a solvent solution or dispersion is blended with one or more active powdery electrode forming materials to form a slurry dispersion or paste. This dispersion or paste is then applied to one or both surfaces of an electroconductive substrate, and dried to form a coherent composite electrode layer. The electrode layer may then be calendared. This method is shown in U.S. Pat. No. 5,776,637 and U.S. Pat. No. 6,200,703, where a fluoropolymer binder is dissolved in NMP.

Surprisingly, it has now been found that by using a granulated form of a polymeric binder composition a better adhesion in the final battery product can be achieved. Advantageously, this slurry produced from agglomerated fluoropolymer composition exhibits lower viscosity and provides better adhesion to the electrode.

Other advantages include: better dispersion of the binder, which in turn reduces binder usage.

### SUMMARY OF THE INVENTION

The invention relates to a method of making an improved battery electrode comprising providing a granulated polymeric binder composition, such that more than 90% by weight, preferably greater than 95% by weight of particles of the granulated polymeric binder composition are 400 um or greater but less than 2.5 mm, preferably the granulated binder composition has a raspberry morphology, combining the granulated binder, solvent and electrode materials to form a slurry, wherein the said granulated polymeric binder composition is dissolved in the solvent, and coating an electrode substrate with the resulting slurry. Preferably the polymeric binder composition comprises a fluoropolymer composition, preferably a polyvinylidene fluoride polymer composition, “PVDF”. By using the granulated polymeric binder composition, Applicant's have found better dissolution of the polymeric binder composition resulting in a decrease in viscosity of at least 5% as compared to the viscosity of when using the same binder in powder form and an increase in peel strength of the cathode. The resulting electrode made using the method of the invention has better adhesion.

Unexpected reduced slurry viscosity and improved adhesion of the polymeric binder composition to an electrode substrate results when a binder powder was subjected to compaction/granulation and then used in the method of making an electrode as compared to using the same binder without granulating (using it in powder form).

Applicants have discovered a method to improve adhesion in a battery electrode. The method comprising dissolving a granulated polymeric binder composition, preferably comprising a fluoropolymer composition, preferably a polyvinylidene polymer composition, in a solvent to form a slurry, adding electrode material to the slurry and then coating an electrode substrate with the slurry containing the active material. The granulated polymer binder composition is characterized in that its apparent density is above 0.4, preferably above 0.6, even more preferably above 0.8 g/cc and wherein the granulated polymer binder is composed of agglomerated particles having a raspberry morphology.

The invention relates to a method for forming an energy storage device, comprising the steps of
a) dissolving a granulated polymeric binder, preferably a fluoropolymer composition in solvent to obtain a binder dispersion;
b) combining said binder dispersion with active powdery electrode-forming materials to form a uniform blend, and
c) applying said uniform blend to at least one surface of an electroconductive substrate to form an electrode,
   wherein greater than 90% of the granulated polymer binder particles are 400 um or greater but less than 2.5 mm, preferably from 400 to 2000 microns, and the bulk density of the polymeric binder is greater than 0.4 g/cc, preferably greater than 0.6 g/cc and wherein the particle has a raspberry morphology. Particle size is measured, by measuring the % passing each mesh sized screen.

The invention further relates to the electrode formed by the method, having better adhesion then a binder formed form the same polymeric binder in powder form.

Aspects of the invention

Aspect 1: A method for producing a battery electrode comprising the steps of
a. providing a granulated polymeric binder composition wherein the binder composition comprises agglomerated particles, preferably having a raspberry morphology, wherein greater than 95% by weight of agglomerated particles are 400 um or greater but less than 2.5 mm, and a bulk density of greater than 0.4 g/cc,
b. combining granulated polymeric binder composition, solvent and electrode material to provide an electrode-forming composition, wherein the polymeric binder composition is dissolved in the solvent,
c. applying the electrode-forming composition onto at least one surface of an electroconductive substrate, and
d. evaporating the organic solvent in the electrode-forming composition to form a composite electrode layer on the electroconductive substrate.

Aspect 2: The method of aspect 1, wherein step (b) comprises
b1. adding the granulated polymeric binder composition to an organic solvent,
b2. mixing until dissolved to provide a solution of the granulated binder,
b3. combining electrode materials and the solution of the granulated binder to provide an electrode-forming composition.

Aspect 3: The method of aspect 1 or 2, wherein said granulated polymeric binder composition comprises a polymer selected from the group consisting of fluoropolymers, SBR, ethylene vinyl acetate (EVA), acrylic polymers, polyurethanes, styrenic polymers, polyamides, polyesters, polycarbonate and thermoplastic polyurethane (TPU) and combinations thereof.

Aspect 4: The method of aspect 1 or 2 wherein said granulated polymeric binder comprises a fluoropolymer.

Aspect 5: The method of aspect 4, wherein the fluoropolymer has a melt viscosity of greater than 5 kPoise, according to ASTM method D-3835 measured at 450° F. (232 C) and 100 sec⁻¹, preferably greater than 15 kPoise.

Aspect 6: The method of aspect 4 wherein said fluoropolymer comprises a polyvinylidene fluoride polymer comprising at least 50% by weight vinylidene fluoride monomer units, preferably at least 75% by weight vinylidene fluoride monomer units.

Aspect 7: The method of aspect 4, wherein said fluoropolymer is a copolymer comprising vinylidene fluoride monomer units and from 1 to 30 weight percent of hexafluoropropene monomer units.

Aspect 8: The method of any one of aspects 1 to 7, wherein said electrode materials includes active material selected from the group consisting of an oxide, sulfide or hydroxide of lithium and a transition metal; carbonaceous materials; nano-titanates and combinations thereof.

Aspect 9: The method of aspect 8 wherein the electrode materials further include an electroconductivity-imparting additive.

Aspect 10: The method of any one of aspects 1 to 7, wherein said electrode material comprises a carbonaceous material in the form of particles having an average diameter of 0.5-100 μm.

Aspect 11: The method of any one of aspects 1 to 10, wherein said agglomerated particles have a bulk density of 0.6 g/cc or greater.

Aspect 12: The method of any one of aspects 1 to 11, wherein said agglomerated particles are greater than 400 um but less than 2000 microns.

Aspect 13: An electrode formed by the method of any one of aspects 1 to 12.

Aspect 14: A battery comprising the electrodes produced by the method of any one of aspects 1 to 12.

### DESCRIPTION OF THE DRAWINGS

FIG. 1 shows a fluoropolymer binder composition powder, magnification of 70.

FIG. 2 shows a fluoropolymer binder composition powder, magnification of 20,000.

FIG. 3 shows a fluoropolymer binder composition powder, magnification of 50,000

FIG. 4 shows a fluoropolymer binder composition granulated, magnification of 70.

FIG. 5 shows a fluoropolymer binder composition granulated, magnification of 10,000.

FIG. 6 shows a fluoropolymer binder composition granulated, magnification of 50,000

### DETAILED DESCRIPTION OF THE INVENTION

As used herein, copolymer refers to any polymer having two or more different monomer units, and would include terpolymers and those having more than three different monomer units.

Percentages, as used herein are weight percentages, unless noted otherwise, and molecular weights are weight average molecular weights, unless otherwise stated.

The references cited in this application are incorporated herein by reference.

A raspberry structure is a material where the particle is comprised of smaller primary particles and can be seen by microscopy. This structure/morphology is well know in the art.

The apparent density is a way to differentiate powder from granules for a given polymer composition. Apparent density is the bulk density of the powder. It provides the mass per unit volume of loose packed powders. This value is a first, low-cost evaluation of a powder to determine consistency from lot to lot. A low apparent density can be an indication of (smaller) fine particles and a high apparent density can be an indication of large particles. Also, if a powder is heavily agglomerated, this may appear as an increase in apparent density. Bulk or Apparent Density is measured by gently introducing a known sample mass into a graduated cylinder, and carefully leveling the powder without compacting it. The apparent untapped volume is then read to the nearest graduated unit.

Powder means that greater than 90% by weight of the particle have a particle size of less than 300 microns, preferably less than 200 microns.

Slurry Viscosity is measured at 25° C. using Brookfield Viscometer. SSA7R chamber is used and spindle number is 15. The solids content (%) of the slurry is in the range of 40 to 87 weight percent. The viscosity can be measured at between 71 to 72 wt percent solids.

The manner of practicing the invention will now be generally described with respect to a specific preferred embodiment thereof, namely polyvinylidene fluoride based polymers prepared in aqueous emulsion polymerization. Although the invention has been generally illustrated with respect to PVDF polymers, one of skill in the art will recognize that analogous polymerization and application techniques can be applied to the preparation of other polymeric binder compositions.

The invention provides for a method of making a binder composition and a method of making an electrode comprising said binder composition. The method comprising dissolving a granulated binder wherein more than 90% by weight, preferably greater than 95% by weight of particles of the granulated binder being 400 micron or greater but less than 2.5 mm, preferably 400 or greater to 2000 micron, and has an apparent density of greater than 0.4 g/cc, preferably greater than 0.6 g/cc. Particle size is measured, by measuring the % by weight passing each mesh sized screen.

It has surprisingly been found that the use of a granulated polymeric binder composition results in lower slurry viscosity and increased adhesion of the slurry to the electrode substrate as compared to using the powder form where greater than 90% of the particles by weight are less than 300 microns.

The fluoropolymer polymeric binder composition is preferably a fluoropolymer composition which can be a homopolymer or copolymer, with or without functional groups. PVDF is a preferred fluoropolymer.

Compaction/granulation of polymers is well known in the art to reduce dust, control particle size, control bulk density or improve dissolution/dispersion rates. See for example https://www.fitzpatrick-mpt.com and brochure from The Fitzpatrick Company 37 Roll Compaction RC-5/09 which discusses granulation.

### Fluoropolymers

The term fluoropolymer denotes any polymer that has in its chain at least one monomer chosen from compounds containing a vinyl group capable of opening in order to be polymerized and that contains, directly attached to this vinyl group, at least one fluorine atom, at least one fluoroalkyl group or at least one fluoroalkoxy group.

Useful fluoropolymers are thermoplastic homopolymers, and copolymers having greater than 50 weight percent of fluoromonomer units by weight, preferably more than 65 weight percent, more preferably greater than 75 weight percent and most preferably greater than 90 weight percent of one or more fluoromonomers. Useful fluoromonomers for forming the fluoropolymer include but are not limited to: vinylidene fluoride (VDF or VF₂), 1,2-difluoroethylene, trifluoroethylene (VF3); tetrafluoroethylene (TFE), trifluoroethylene (TrFE), chlorotrifluoroethylene (CTFE), hexafluoropropene (HFP), vinyl fluoride (VF), hexafluoroisobutylene (HFIB), perfluorobutylethylene (PFBE), pentafluoropropene, 3,3,3-trilluoro-1-propene, 2-trifluoromethyl-3,3,3-trifluoropropene, fluorinated (alkyl)vinyl ethers including perfluoromethyl ether (PMVE), perfluoroethylvinyl ether (PEVE), perfluoropropylvinyl ether (PPVE), perfluorobutylvinyl ether (PBVE), longer chain perfluorinated vinyl ethers, fluorinated dioxoles such as perfluoro(1,3-dioxole); perfluoro(2,2-dimethyl-1,3-dioxole) (PDD), partially- or per-fluorinated alpha olefins of C₄ and higher, partially- or per-fluorinated cyclic alkenes of C₃ and higher, and combinations thereof.

The invention applies to thermoplastic fluoropolymers, homopolymers and copolymers. Preferred polymeric binder includes but are not limited to homopolymers of polyvinylidene fluoride and copolymers of polyvinylidene fluoride and hexafluoropropene (VDF-HFP).

Vinylidene fluoride polymers will be used to illustrate the invention, and are the preferred polymers (including homopolymer and copolymers). Such copolymers include those containing at least 50 weight percent, preferably at least 75 weight %, more preferably at least 80 weight %, and even more preferably at least 85 weight % of vinylidene fluoride copolymerized with one or more comonomers. Example comonomers may be selected from the group consisting of tetrafluoroethylene, trifluoroethylene, chlorotrifluoroethylene, hexafluoropropene, vinyl fluoride, pentafluoropropene, tetrafluoropropene, trifluoropropene, perfluorinated vinyl ethers, such as, pertluoroethyl vinyl ether, and perfluoro-2-propoxypropyl vinyl ether, perfluoromethyl vinyl ether, pertluoropropyl vinyl ether and any other monomer that would readily copolymerize with vinylidene fluoride, one or more of partly or fully fluorinated alpha-olefins such as 3,3,3-trifluoro-1-propene, 1,2,3,3,3-pentafluoropropene, 3,3,3,4,4-pentafluoro-1-butene, the partly fluorinated olefin hexafluoroisobutylene, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene. Other monomers units in these polymers may include any monomer that contains a polymerizable C═C double bond. Additional monomers could be 2-hydroxyethyl allyl ether, 3-allyloxypropanediol, allylic monomers, ethene or propene, acrylic acid, methacrylic acid.

In one embodiment, up to 30%, preferably up to 25%, and more preferably up to 15% by weight of hexafluoropropene (HFP) units and 70% or greater, preferably 75% or greater, more preferably 85% or greater by weight or more of VDF units are present in the vinylidene fluoride polymer. It is desired that the HFP units be distributed as homogeneously as possible to provide PVDF-HFP copolymer with excellent dimensional stability in the end-use environment.

Most preferred copolymers and terpolymers of the invention are those in which vinylidene fluoride units comprise greater than 50 percent of the total weight of all the monomer units in the polymer, preferably at least 60 wt percent, and more preferably, comprise greater than 70 percent of the total weight of the units. Copolymers, terpolymers and higher polymers of vinylidene fluoride may be made by reacting vinylidene fluoride with one or more monomers from the group consisting of vinyl fluoride, trifluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, and hexafluoropropene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated,

### Emulsion Process

Fluoropolymers, such as polyvinylidene-based polymers, can be made by any process known in the art, using aqueous free-radical emulsion polymerization—although suspension, solution and supercritical CO₂ polymerization processes may also be used. Processes such as emulsion and suspension polymerization are preferred and are described in U.S. Pat. No. 6,187,885, and EP0120524. Most preferred is emulsion polymerization.

In a general emulsion polymerization process, a reactor is charged with deionized water, water-soluble surfactant capable of emulsifying the reactant mass during polymerization and optional paraffin wax antifoulant. The mixture is stirred and deoxygenated. A predetermined amount of chain transfer agent, CTA, is then introduced into the reactor, the reactor temperature raised to the desired level and monomer (for example vinylidene fluoride and possibly one or more comonomers) are fed into the reactor. Once the initial charge of monomer is introduced and the pressure in the reactor has reached the desired level, an initiator is introduced to start the polymerization reaction. The temperature of the reaction can vary depending on the characteristics of the initiator used and one of skill in the art will know how to do so. Typically the temperature will be from about 30° to 150° C., preferably from about 60° to 120° C. Once the desired amount of polymer has been reached in the reactor, the monomer feed will be stopped, but initiator feed is optionally continued to consume residual monomer. Residual gases (containing unreacted monomers) are vented and the latex recovered from the reactor.

The surfactant used in the polymerization can be any surfactant known in the art to be useful in PVDF emulsion polymerization, including perfluorinated, partially fluorinated, and non-fluorinated surfactants. Preferably the PVDF emulsion is fluorosurfactant free, with no fluorosurfactants being used in any part of the polymerization. Non-fluorinated surfactants useful in the PVDF polymerization could be both ionic and non-ionic in nature including, but are not limited to, 3-allyloxy-2-hydroxy-1-propane sulfonic acid salt, polyvinylphosphonic acid, polyacrylic acids, polyvinyl sulfonic acid, and salts thereof, polyethylene glycol and/or polypropylene glycol and the block copolymers thereof, alkyl phosphonates and siloxane-based surfactants.

The polymerization results in a latex generally having a solids level of 10 to 60 percent by weight, preferably 10 to 50 percent, and having a weight average particle size of less than 500 nm, preferably less than 400 nm, and more preferably less than 300 nm. The weight average particle size is generally at least 20 nm and preferably at least 50 nm.

To be used in the present invention the latex is spray dried into a powder form and then the powder is granulated such that greater than 90%, preferably greater than 95% by weight of agglomerated (granular) particles are 400 um or greater but less than 2.5 mm, preferably 400 to 2000 micron, and a bulk density of greater than 0.4 g/cc, preferably greater than 0.6 g/cc. Said granular particles have a raspberry form.

The polymeric binder composition of the invention is any thermoplastic polymer typically used as electrode binder. The polymer is typically a semi crystalline polymer.

In some embodiments the binder is a fluoropolymer composition and has a melting point above 100 C, preferably above 145 C, preferably greater than 155 C.

The fluoropolymer composition for use in the electrode composition preferably has a high molecular weight. By high molecular weight, as used herein is meant fluoropolymer (preferably PVDF) having a melt viscosity of greater than 10 kiloPoise, preferably greater than 15 kPoise, more preferably greater than 20 kPoise, and most preferably greater than 25 kPoise according to ASTM method D-3835 measured at 450° F. (232° C.) and 100 sec⁻¹.

### Electrode Slurry

Cathode forming slurries comprise solvent, electrode material (including a cathode active material and a conductive material) and polymeric binder. Anode forming slurries comprise solvent, electrode material (including an anode active material), and a polymeric binder.

### Solvents for Slurry

Any suitable organic solvent that dissolves the polymeric binder may be used. The organic solvent used for dissolving the polymeric binder composition (preferably a fluoropolymer, more preferably vinylidene fluoride polymer composition) to provide the binder solution according to the present invention may preferably be a polar one, examples of which may include: N-methyl-2-pyrrolidone (NMP), N-ethyl-2-pyrrolidone, dimethylformamide, N,N -dimethylacetamide, N,N-dimethylsulfoxide, hexamethylphosphamide, dioxane, tetrahydrofuran, tetramethylurea, triethyl phosphate, and trimethyl phosphate. These solvents may be used singly or in mixture of two or more species. The granulated polymeric binder composition can be dissolved in the solvent to make a polymeric binder solution.

### Electrode Material

An electrode-forming composition may be obtained by adding and dispersing electrode materials (an active substance and optional additives, such as an electroconductivity-imparting additive) with the polymeric binder and solvent according to the present invention to provide an electrode forming slurry. The electrode materials are preferably, dry and powdery. Preferably the granulated polymeric binder composition is first dissolved in the solvent (providing a binder solution) and then the electrode materials are added.

In the case of forming a positive electrode (cathode), electrode materials include cathode active material and an electroconductivity-imparting additive (conductive material). In the case of forming a negative electrode (anode), electrode materials comprise an anode active material preferably carbonaceous material.

In the case of forming a positive electrode (cathode), the cathode active material may comprise a composite metal chalcogenide represented by a general formula of LiMY₂, wherein M denotes at least one species of transition metals such as Co, Ni, Fe, Mn, Cr and V; and Y denotes a chalcogen, such as O or S. Among these, it is preferred to use a lithium-based composite metal oxide represented by a general formula of LiMO₂, wherein M is the same as above. Preferred examples thereof may include: LiCoO₂, LiNiO₂, LiNiₓCO₁₋ₓO₂, and spinel-structured LiMn₂O₄. Among these, it is particularly preferred to use a Li—Co or Li—Ni binary composite metal oxide or Li—Ni—Co ternary composite metal oxide inclusively represented by a formula of LiNiₓCo₁₋ₓO₂ (0≤x≤1) in view of a high charge-discharge potential and excellent cycle characteristic. Cathode active materials include but are not limited to LiCoO2, LiNi₁₋ₓCoₓO₂, Li₁₋ₓNi_{1-y}Co_{y}O₂, LiMO₂(M=Mn, Fe), Li[NiₓCo₁₋₂ₓMnₓ]O, LiNiₓMn_{y}Co_{z}O₂, LiM₂O₄(M=Ti, V, Mn), LiMₓMn₂₋ₓO₄ (M=Co²⁺, Ni²⁺, Mg²⁺, Cu²⁺, Zn²⁺, Al³⁺, Cr³⁺), LiFePO₄, LiMPO₄(M=Mn, Co, Ni) and LiNiₓCoyAlzO₂. Preferred positive electrode materials include, but are not limited to, LiCoO₂, LiNiₓCo₁₋ₓO₂, LiMn₂O₄, LiNiO₂, LiFePO4, LiNiₓCo_{y}Mn_{z}Oₘ, LiNiₓ₋Mn_{y}Al_{z}Oₘ where x+y+z=1 and m is an integer representing the number of oxygen atom in the oxide to provide an electron-balanced molecule; as well as lithium-metal oxides such as lithium cobalt oxide, lithium iron phosphate, lithium manganese phosphate, lithium-nickel oxide, and lithium-manganese oxide.

In the case of forming a positive electrode (cathode) an electroconductivity-imparting additive may be added in order to improve the conductivity of a resultant composite electrode layer formed by applying and drying of the electrode-forming composition of the present invention. Such an electroconductivity-imparting additive may preferably be used in an amount of 0 to 10 wt. or optionally 0.1-10 wt. parts per 100 wt. parts of the active material constituting the positive electrode (cathode). Conductive agents include but are not limited to carbonaceous materials, such graphite, graphite fine powder and fiber, carbon black, Ketjen black, carbon fiber, carbon nanotubes, and acetylene black, and fine powder and fiber of metals, such as nickel and aluminum. For electroconductive carbon black, preferably the average particle size (diameter) is from 10-100 nm as measured by observation through an electron microscope.

In the case of forming a negative electrode (anode), the electrode material (active substance) may preferably comprise a carbonaceous material, such as graphite, activated carbon or a carbonaceous material obtained by carbonization of phenolic resin, and pitch.

The slurry may contain other additives. Such additives are known by those skilled in the art. The binder composition of the invention may optionally include 0 to 15 weight percent based on the polymer, and preferably 0.1 to 10 weight percent, of additives, including but not limited to thickeners, pH adjusting agents, acid, rheology additives, anti-settling agents, surfactants, wetting agents, fillers, anti-foaming agents, and fugitive adhesion promoters. Additional adhesion promoters may also be added to improve the binding characteristics and provide connectivity that is non-reversible.

### Forming the Electrode

The positive or negative electrode-forming slurry composition may be used for forming an electrode structure. More specifically, the slurry composition may be applied onto at least one surface, preferably both surfaces, of an electroconductive substrate comprising a foil or wire net of a metal, such as iron, stainless steel, steel, copper, lithium, aluminum, nickel, silver or titanium and having a thickness of, e.g., 5-100 μm, or 5-20 μm for a small-sized battery, and dried at, e.g., 50-170° C., to form a composite electrode layer of, e.g., 10-1000 μm, preferably 10-200 μm, in thickness for a small-sized battery, thereby providing an electrode structure for a non-aqueous-type battery.

The components of the slurry are combined to form a homogenous slurry. Example equipment used to combine the components include but are not limited to ball mills, magnetic stirrers, planetary mixers, high speed mixers, homogenizers and static mixers. A person of skill in the art can select adequate equipment for the purpose. For obtaining the polymeric binder solution according to the present invention, it is preferred to dissolve about 0.1-20 wt. parts, particularly 1-15 wt. parts, of the above-mentioned granulated polymeric binder composition in 100 wt. parts of solvent. Below 0.1 wt. part, the polymer occupies too small a proportion in the solvent, thus being liable to fail in exhibiting a sufficient binder performance. Above 20 wt. parts, the resultant solution is liable to have an excessively high viscosity, thus making it difficult to prepare an electrode-forming slurry composition.

Preferably, the solid content (%) of the slurry is preferably in the range of 40 to 87 weight percent, more preferably about 50 to 85% by weight.

The formulation for a cathode among active materials, conductive agent and polymeric binder can vary. Preferably the amount of active material is about 90-99% by weight; the amount of conductive agent is about 0.5 to 5% by weight and the amount of polymeric binder is about 0.5 to 5% by weight based on total weight of active material, conductive agent and polymeric binder composition.

The formulation for an anode comprises conductive agent and polymeric binder. The amount of binder in an anode is about 0.5 to 5% by weight based on total weight of anode active material, and polymeric binder composition.

### Uses

The electrodes formed by the method of the invention can be used to form electro-chemical devices, including but not limited to batteries, capacitors, and other energy storage devices.

More specifically, the secondary battery basically includes a laminate structure including a positive electrode, a negative electrode and a separator disposed between the positive and negative electrodes. The separator comprising a fine porous film of a polymeric material, such as PVDF, polyethylene or polypropylene, impregnated with an electrolytic solution. The non-aqueous electrolyte solution impregnating the separator may comprise a solution of an electrolyte, such as a lithium salt, in a non-aqueous solvent (organic solvent). Examples of the electrolyte may include: LiPF6, LiAsF6, LiClO4, LiBF4, CH3SO3Li, CF3SO3Li, LiN(SO2CF3)2, LiC(SO2CF3)3, LiCl, and LiBr. Examples of the organic solvent for such an electrolyte may include: propylene carbonate, ethylene carbonate, 1,2-dimethoxyethane, 1,2-diethoxyethane, dimethyl carbonate, diethyl carbonate, methyl ethyl carbonate, γ-butyrolactone, methyl propionate, ethyl propionate, and mixtures of these, but they are not exhaustive.

### EXAMPLES

### Test Methods:

Particle size of activated carbon is measured using a TYLER RX-29 sieve shaker.

### Examples

Cathode slurry preparation A cathode slurry formulation is comprised of organic solvent such as N-Methyl-2-pyrrolidone (NMP), or N-ethyl-2-pyrrolidone, at least one cathode active materials, at least one conductive material and polymeric binder composition.

Dispermat (BYK-Gardner) is used for lab scale mixing.

### Example 1. Li[Ni_{0.6}Co_{0.2}Mn_{0.2}]O₂/Super P/Kynar® HSV900=96/2/2

### Preparation of Binder Solution

For Kynar® HSV900 (GRANULATED) greater than 90% of the particles are between 400 micron and 2 mm.

For Kynar® HSV900 (control). greater than 90 percent by weight of the particles are from 5 to 30 microns.

A 500 mL stainless steel vessel was charged with 300 g of NMP and 27 g of PVDF. The vessel was first charged with NMP and then HSV900 (GRANULED) or Kynar® HSV900 was added on the top. The different mixing efficiency between granulated powder and fine powder was easily seen once mixing started. Fine powder is hardly immersed into NMP since it formed gel like balls on the surface. In sharp contrast, HSV900 (GRANULED) showed excellent mixing behavior due to higher bulk density than fine powder. Using a Dispermat (BYK Gardner) mixer, NMP and PVDF was mixed for 1 hour at 60° C. Then the solution was allowed to cool down. To check the dissolution efficiency the solid content was checked. Solid content measurement is conducted using Mettler Toledo ME204. The aliquot of each solution is introduced to 160° C. oven for 1 hour.

TABLE 1
Solid content of 9 wt % of PVDF in NMP solution

| Kynar ® HSV900 | Kynar ® HSV900 |
|---|---|
| (GRANULED) | Control |
| 8.99% | 8.96% |

Viscosity measurement was conducted at 25° C. using Brookfield Viscometer. SSA7R chamber is used and spindle number is 15.

TABLE 2
Solution Viscosity 9 wt % of PVDF/NMP solution at 5.28/sec.

| Kynar ® HSV900 | Kynar ® HSV900 | % increase over |
|---|---|---|
| (GRANULED) | Control | Control |
| 10,557 cP | 9,539 cP | 10.7% |

### Preparation of Cathode Slurry

Charged 10 g of Super P (conductive carbon black from TIMCAL) and 111 g of 9 wt % PVDF solution into 500 mL stainless steel vessel. Allowed ambient mixing for 1 min. Charged 480 g of NMC622 into the vessel and mixed for 1 min. Finally, increased rpm to achieve desirable slurry. from the rpm was between 2000 rpm to 4000 rpm. After 1 hour, the resulting slurry was analyzed; Slurry viscosity, peel and solid Content. Additional solvent was added to attain the solid content.

TABLE 3
Solid content of cathode slurry made
of corresponding Kynar(R) PVDF.

| Kynar ® HSV900 | |
|---|---|
| (GRANULED) | Kynar ® HSV900 |
| 71.7% | 71.2% |

TABLE 4
Viscosity of cathode slurry made of corresponding Kynar ®PVDF.

| Kynar ® HSV900 | Kynar ® HSV900 | % Decrease over |
|---|---|---|
| (GRANULED) | Control | Control |
| 12,370 cP | 13,502 cP | 8.4% |

Slurry viscosity gives unexpected results as shown in Table 4. Viscosity measurement was conducted at 25° C. using Brookfield Viscometer. SSA7R chamber is used and spindle number is 15. Even though the only difference between Kynar® HSV900 (GRANULED) and Kynar® HSV900 is its bulk density, resulting slurries give quite different rheological behavior. It illustrates mixing efficiency in solution preparation step affects the entire cathode slurry behavior.

TABLE 5
Peel data of cathode in arbitrary unit.

| Kynar ® HSV900 | | |
|---|---|---|
| (GRANULED) | Kynar ® HSV900 | Peal Increase |
| 99.7 | 88.7 | 12.4% |

Slurry then was casted onto Aluminum foil current collector. Thickness can vary, from 50 um to 100 um, more preferably 70 um for lab test. The coated current collector was placed in 120° C. oven for 30 min. Finally, the resulting cathode was compressed in roll presser. Cool pressed. The compression ratio may be 20˜30% (100 um->70˜80 um).

To test 180 degree peel, the cathode is cut into 1 inch-width and 15 cm-long strips. Adhere double side tape on a substrate. Then put the strip on one side of tape in order to test peel. Finally, peel tester records applied load to detach cathode from tape. Herein, only relative number is given since the value itself may be different depending on peel tester supplier, current collector, head speed of peel tester. Interestingly, Kynar HSV900 (GRANULATED) which gives better dissolution efficiency shows higher peel than Kynar HSV900.

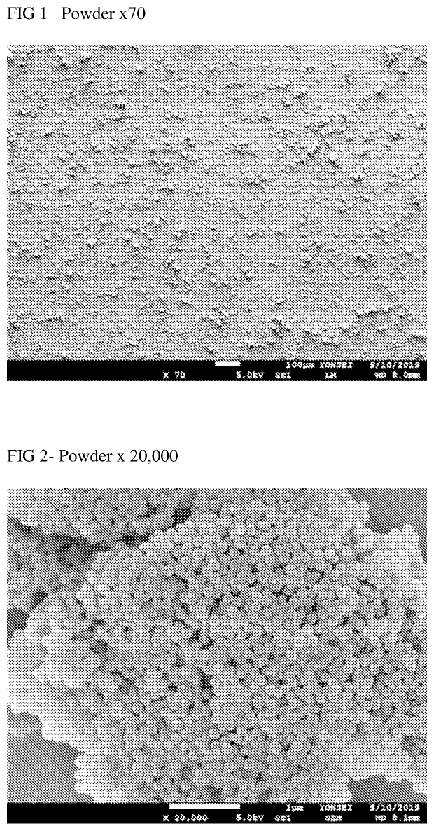

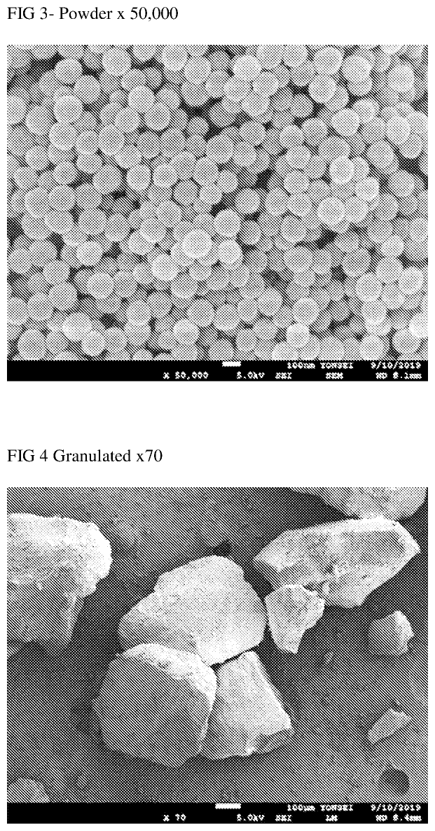

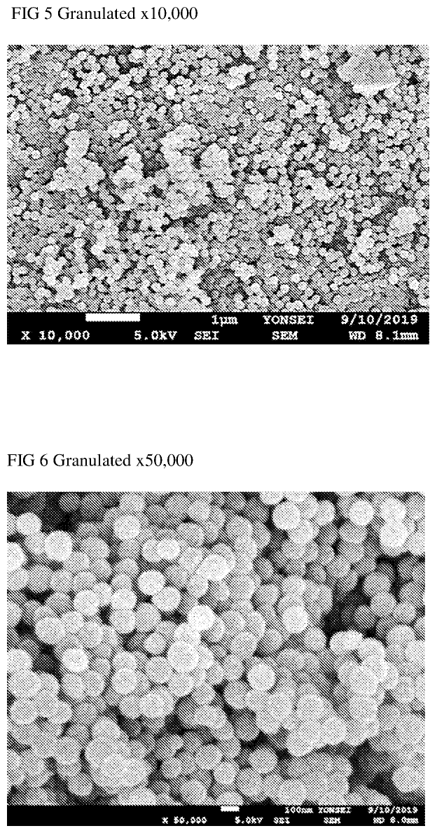

FIGS. 1 to 3 shows the fluoropolymer powder. The figures show that the powder is an agglomeration of individual primary particles making up one powder particle. the average size of the powder particle in the figures is from about 1 to 50 microns. FIGS. 4 to 6 show the average size of the granulated fluoropolymer is greater than 400 microns and that is made of agglomerated primary particles. SEM figures show the granulation process doesn't change the shape of the individual PVDF particles. The bulk density is increased by granulation.

1. A method for producing a battery electrode comprising the steps of
a. providing a granulated polymeric binder composition wherein the binder composition comprises agglomerated particles, wherein greater than 95% by weight of agglomerated particles are 400 um or greater but less than 2.5 mm, and a bulk density of greater than 0.4 g/cc,
b. combining granulated polymeric binder composition, solvent and electrode material to provide an electrode-forming composition, wherein the polymeric binder composition is dissolved in the solvent,
c. applying the electrode-forming composition onto at least one surface of an electroconductive substrate, and
d. evaporating the organic solvent in the electrode-forming composition to form a composite electrode layer on the electroconductive substrate.

2. The method of claim 1, wherein step (b) comprises
b1. adding the granulated polymeric binder composition to an organic solvent,
b2. mixing until dissolved to provide a solution of the granulated polymeric binder,
b3. combining electrode materials and the solution of the granulated polymeric binder to provide an electrode-forming composition.

3. The method of claim 1, wherein said granulated polymeric binder composition comprises a polymer selected from the group consisting of fluoropolymers, SBR, ethylene vinyl acetate (EVA), acrylic polymers, polyurethanes, styrenic polymers, polyamides, polyesters, polycarbonate and thermoplastic polyurethane (TPU) and combinations thereof.

4. The method of claim 1, wherein said granulated polymeric binder composition comprises a fluoropolymer.

5. The method of claim 2, wherein said granulated polymeric binder composition comprises a fluoropolymer.

6. The method of claim 4, wherein the fluoropolymer has a melt viscosity of greater than 5 kPoise, according to ASTM method D-3835 measured at 450° F. (232 C) and 100 sec⁻¹.

7. The method of claim 4, wherein said fluoropolymer comprises a polyvinylidene fluoride polymer comprising at least 50% by weight vinylidene fluoride monomer units.

8. The method of claim 4, wherein said fluoropolymer is a copolymer comprising vinylidene fluoride monomer units and from 1 to 30 weight percent of hexafluoropropene monomer units.

9. The method of claim 1, wherein said electrode materials includes active material selected from the group consisting of an oxide, sulfide or hydroxide of lithium and a transition metal; carbonaceous materials; nano-titanates and combinations thereof.

10. The method of claim 9 wherein the electrode materials further include an electroconductivity-imparting additive.

11. The method of claim 1, wherein said electrode material comprises a carbonaceous material in the form of particles having an average diameter of 0.5-100 μm.

12. The method of claim 1, wherein said agglomerated particles have a bulk density of 0.6 g/cc or greater.

13. The method of claim 1, wherein said agglomerated particles are greater than 400 μm but less than 2000 microns.

14. An electrode formed by the method of claim 1.

15. A battery comprising the electrodes produced by the method of claim 1.
